(19) United States
(12) Patent Application Publication
(10) Pub. No.: US 2026/0054533 A1
(43) Pub. Date: Feb. 26, 2026

(54) ELECTRIC VEHICLE WITH INTERNAL WINCH

(71) Applicant: FCA US LLC, Auburn Hills, MI (US)

(72) Inventors: Christopher C. Kennedy, Auburn Hills, MI (US); Brian M. Swanson, Auburn Hills, MI (US); Richard S. Silbert, Auburn Hills, MI (US)

(21) Appl. No.: 18/812,190

(22) Filed: Aug. 22, 2024

(51) Int. Cl. B60D 1/18; B66D 1/12

(52) U.S. Cl. CPC B60D 1/185; B66D 1/12

(57) ABSTRACT

An electric vehicle includes a vehicle substructure, vehicle body panels coupled to the vehicle substructure, a compartment bounded on multiple sides by the vehicle body panels, a winch received within the compartment, and a winch base coupled to the winch and to the vehicle substructure to support the winch during operation of the winch. The winch includes a cable that extends through an opening formed in one of the vehicle body panels so that the cable is accessible from an outside of the vehicle.

### FIELD

The present disclosure relates to an electric vehicle having an internal winch.

### BACKGROUND

Some offroad vehicles include a winch mounted to a front bumper that is connected directly to a vehicle frame. The winch is located outside of the vehicle body, in front of a front fascia of the vehicle body, and is exposed on the bumper and fully visible from outside the vehicle. Thus, the winch is exposed to the environment, and the winch can negatively affect vehicle aerodynamics and reduce vehicle energy efficiency.

### SUMMARY

In at least some implementations, an electric vehicle includes a vehicle substructure, vehicle body panels coupled to the vehicle substructure, a compartment bounded on multiple sides by the vehicle body panels, a winch received within the compartment, and a winch base coupled to the winch and to the vehicle substructure to support the winch during operation of the winch. The winch includes a cable that extends through an opening formed in one of the vehicle body panels so that the cable is accessible from an outside of the vehicle.

In at least some implementations, the body panels define a front end of a vehicle body and include a hood and a front fascia. In at least some implementations, the cable opening is provided in the front fascia. In at least some implementations, the winch is accessible from outside the vehicle when the hood is in an open position.

In at least some implementations, an electric drive module is secured to the vehicle substructure and the winch base and the winch are located above the electric drive module. In at least some implementations, the winch base and the winch are located above the electric drive module, below the hood and behind the front fascia.

In at least some implementations, a storage compartment is provided in the front compartment, the storage compartment is defined in part by a body received in the front compartment, and the winch is received in the storage compartment. In at least some implementations, the winch base extends through openings formed in the body so that part of the winch base is received within the storage compartment and part of the winch base is located outside of the storage compartment. In at least some implementations, a cover separates a first part of the storage compartment in which the winch is located from a second part of the storage compartment.

In at least some implementations, the winch includes a casing having a first part and a second part, and a spool that extends between the first part and the second part, and wherein each of the first part and the second part are coupled to the winch base.

In at least some implementations, a control module is coupled to the electric drive module and wherein the winch base and the winch are also located above the control module.

In at least some implementations, a cooling assembly within the front compartment and associated with the electric drive module, and wherein the cable is routed from the cable opening and to the winch in an area above the cooling assembly.

In at least some implementations, an electric vehicle includes a vehicle substructure including a pair of spaced apart rails extending in a fore-aft direction, vehicle body panels coupled to the vehicle substructure, the vehicle body panels including a front fascia, a pair of side panels on opposite sides of the front fascia and a hood of the vehicle, a front compartment bounded on multiple sides by the vehicle body panels, an electric drive module received in the front compartment and connected to the vehicle substructure and arranged to provide propulsive force for the vehicle, a winch received within the front compartment, the winch including a cable that extends through an opening formed in the front fascia, and a winch base coupled to the winch and to both of the rails.

In addition to the foregoing, in at least some implementations a storage compartment is defined in the front compartment, the storage compartment is defined in part by a body received in the front compartment and the winch is received in the storage compartment. In at least some implementations, the winch base extends through openings formed in the body so that part of the winch base is received within the storage compartment and part of the winch base is located outside of the storage compartment.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a perspective view of an electric vehicle;

FIG. 2 is a sectioned perspective view of part of a front end of the vehicle;

FIG. 3 is a sectioned side view of the front end of the vehicle; and

FIG. 4 is a sectioned front view showing some of the components in the front end of the vehicle.

### DETAILED DESCRIPTION

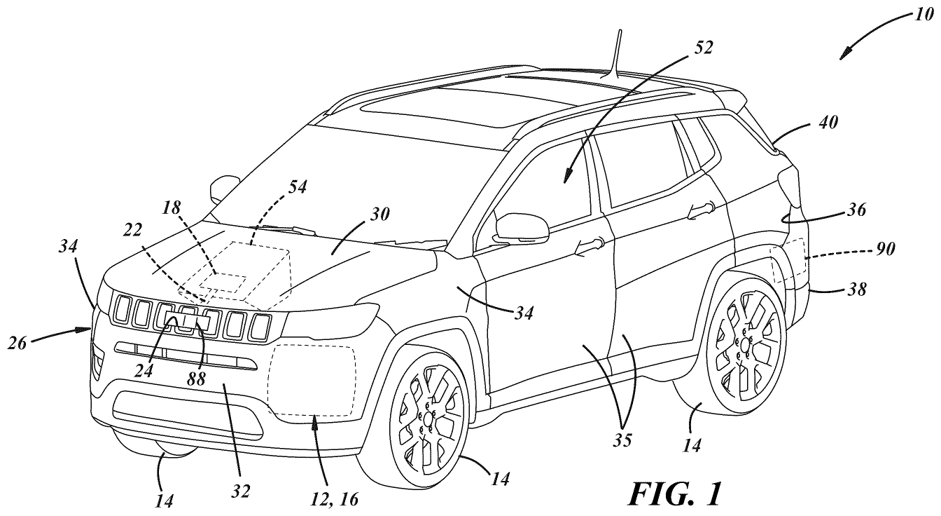

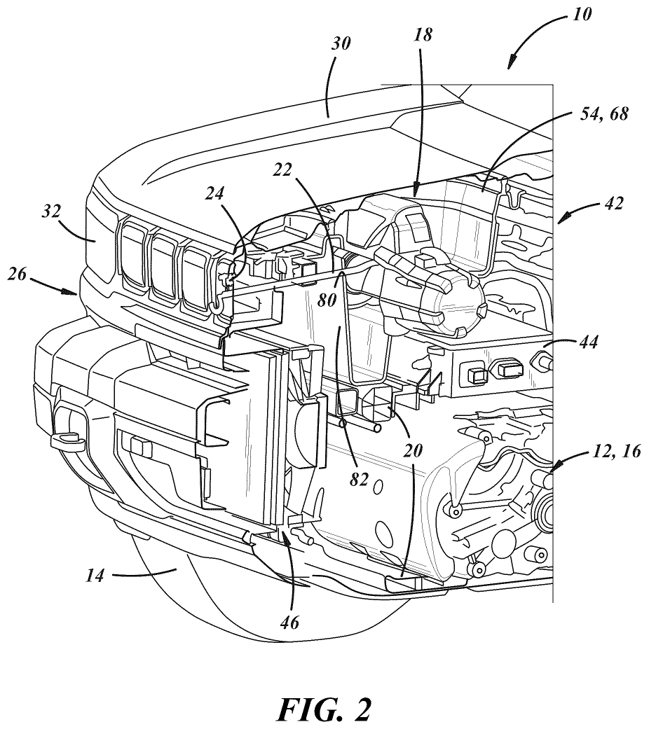

Referring in more detail to the drawings, FIG. 1 shows an electric vehicle 10. The term “electric vehicle” as used herein includes vehicles that have at least one electric motor 12 that delivers drive torque to a vehicle wheel 14, such as gasoline hybrid electric vehicle, plug-in hybrid electric vehicle, range-extended electric, and battery electric vehicles. In at least some implementations, the electric vehicle 10 is a battery electric vehicle (BEV) with propulsion forces provided by one or more electric motors 12 in an electric drive module (EDM) 16. As set forth in more detail below, and as shown in FIGS. 2-4, a winch 18 is mounted within the vehicle 10, to a substructure 20 of the vehicle 10, and the winch 18 includes a cable 22 that is taken up and paid out through a cable opening 24 in part of the vehicle body 26.

As shown in FIGS. 2-4, the vehicle 10 has a unibody style substructure 20 (e.g. less than full-frame vehicle). A front end 28 of the vehicle 10 includes body panels mounted to the vehicle substructure 20. The body panels may include, for example and as best shown in FIG. 1, a hood 30, front fascia 32 and left and right side panels 34 (e.g. front quarter panels and the like), and other panels like doors 35, rear side panels 36 and a rear bumper/fascia 38 and/or liftgate 40 or trunk, as is known. As shown in FIGS. 2-4, the body panels surround and may define at least part of a front compartment 42 of the vehicle 10.

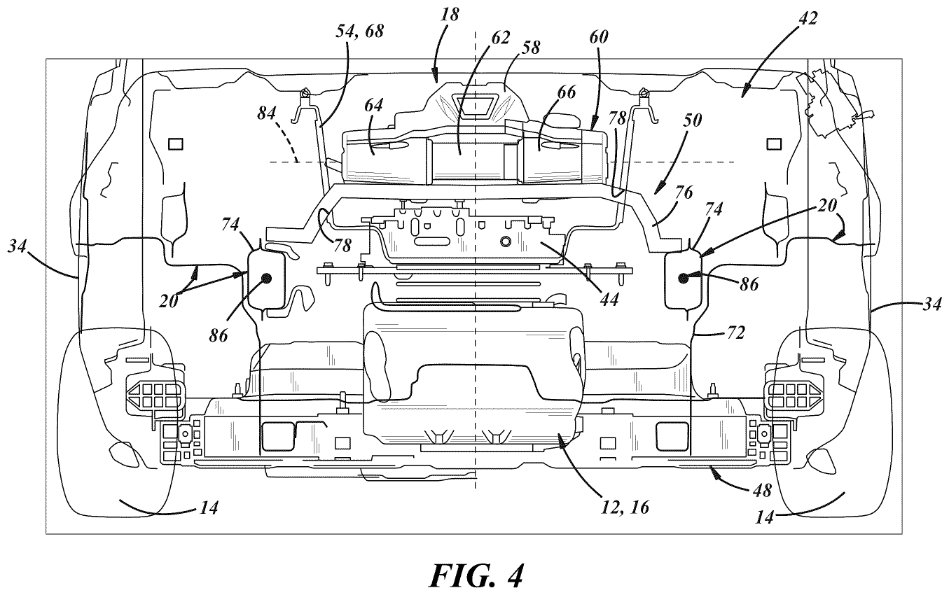

In at least some implementations, the electric drive module 16 is received within the front compartment 42 and is configured to generate and transfer drive torque for vehicle propulsion. The EDM 16 generally includes one or more electric drive units or motors (e.g., electric traction motors), a gearbox assembly, and one or more control modules, such as a powertrain controller or battery charging controller 44. A cooling assembly 46 (e.g. heat exchanger or radiator) may be located between the EDM 16 and the front body panel/fascia 32 and may help control the temperature of the EDM 16 and related electronics/controllers. The EDM 16 may be mounted to the vehicle substructure 20 and may be integrated with a front axle assembly 48 (FIG. 4) or otherwise relatively lowly mounted in the vehicle 10. This provides significant space 50 within the front compartment 42 above the EDM 16, that in a combustion engine vehicle would be consumed by the engine and other components (with a front mounted engine). The space 50 is in front of a vehicle passenger compartment 52 (FIG. 1), behind the front fascia 32, between the side body panels 34 and below the hood 30. In BEVs, part of this space 50 is typically used for a storage compartment 54, sometimes called a front trunk or “frunk”, to provide a cargo storage area in the front compartment 42.

In at least some implementations, the front compartment 42 includes or contains the winch 18. The winch 18 may be electrically powered and coupled to the vehicle electrical system 56 in any desired way. As shown in FIG. 4, the winch 18 includes a main body or casing 58. A winch motor 60 is received in the casing 58, along with gears to increase the torque of the winch 18, and to drive a spool 62 of the winch 18. As shown, the spool 62 may be journaled for rotation between first and second parts 64, 66 of the casing, and the spool 62 may be exposed between the first and second parts 64, 66 to enable the cable 22 to be wrapped onto and unwrapped from the spool 62.

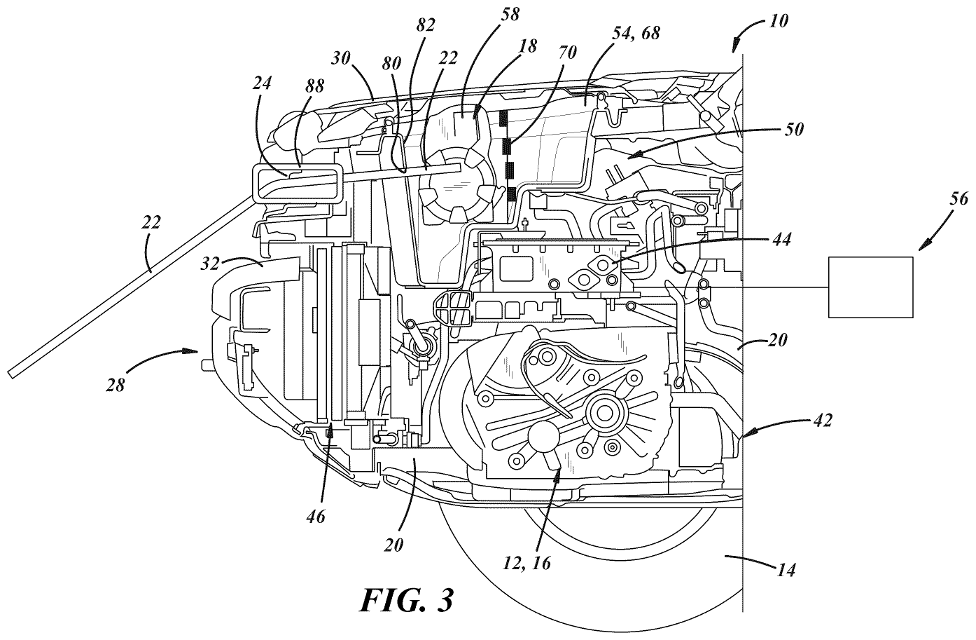

So that the winch 18 is at least somewhat protected from the elements and not visible from the exterior of the vehicle 10 (at least when the hood is closed), the winch 18 may be fully received within the front compartment 42. That is, the main body or casing 58 of the winch 18 may be fully enclosed within the front compartment 42, and in the frunk or other storage compartment 54 in at least some implementations. To facilitate use of the winch 18, part of the cable 22 that is taken up and paid out from the winch spool 62, in known manner, extends from the winch 18 and through the cable opening 24 in a body panel of the vehicle 10 so that the cable 22 is accessible outside the vehicle 10 for use. In the example shown, the winch 18 is received in the storage compartment 54 which space may be defined at least in part by a body 68 (e.g. a molded plastic tub) received between the hood 30 and the EDM 16, and which encloses part of the storage compartment 54. The storage compartment body 68 may enclose/define the sides and bottom of the storage compartment 54, and the hood 30 may be received over a top of the storage compartment 54, together providing an enclosed space. If desired, the winch 18 may be received outside of the storage compartment 54, and adjacent thereto in the front compartment 42. Further, a dividing wall 70 or cover, shown by dashed line in FIG. 3, may be provided to separate the winch 18 from the remainder of the interior of the storage compartment 54, if desired. The winch 18 may be located so that it is easily accessible by opening the vehicle hood 30, for example.

In FIG. 4, a front view of the front compartment 42 is shown. In the front compartment 42 are received part of the unibody substructure 20 including a cradle 72 for the EDM 16 and other components, and a pair of side rails 74 that extend in the fore-aft direction (e.g. toward the front and rear of the vehicle 10). A winch base 76 is connected/fixed to both rails 74 (e.g. by suitable mechanical couplers like bolts, or welds) and the winch 18 is fixed to the base 76 (e.g. by suitable mechanical couplers like bolts, or welds). In the implementation shown, both the first part and the second part 64, 66 of the casing 58 are separately connected to the winch base 76, providing strong support for the casing parts on opposite ends of the spool 62. The base 76 may be of any suitable construction, such as a metal plate or bracket, and may extend out of openings 78 through opposite sides of the storage compartment body 68, in implementations in which the winch 18 is received within the storage compartment body 68. The winch base 76 may be shaped so that it extends above components that are above the EDM 16, such as the module 44 as shown in FIG. 4. In this way, the winch 18 is firmly connected to the vehicle substructure 20 to support the winch 18 in operation thereof during which relatively high forces may be generated. Electric vehicles can be heavy, and so the winch 18 needs to be strongly supported to enable the winch 18 to move the vehicle 10 if needed to winch the vehicle out of trouble. To accommodate the cable 22, as shown in FIG. 3, the storage compartment body 68 would also include an opening 80 through a forwardly oriented wall 82 of the storage compartment body 68 (e.g. the wall nearest the front of the vehicle 10).

As shown in FIG. 4, the winch 18 is coupled to the rails 74 so that an axis 84 about which the spool 62 rotates is perpendicular to centerlines 86 of the rails 74, and the cable 22 extends generally parallel to the rails 74. Further, the winch 18 is above the EDM 16 and below the vehicle hood 30. In this orientation, the cable opening 24 may conveniently be provided through the front body panel (e.g. front fascia 32) of the vehicle 10 at a height generally aligned with the spool 62. To control pay out and take up of the cable 22, the vehicle 10 may, as shown in FIGS. 1 and 2, include a pulley or other cable guide 88, recognizing that the cable 22 may be wrapped around and cover some axial length of the spool 62. The cable guide 88 may extend from the storage compartment body 68 to the front fascia 32 and cable opening 24, and may be fixed or movable to accommodate cable movement relative to the spool. Without a cable guide 88, the body panel having the cable opening 24 would need to be designed to accommodate the cable 22 to prevent extreme rubbing against the panel from within the opening (e.g. reinforcement around the cable opening 24, or a durable, non-wear surface around the opening), or the cable opening 24 could be elongated (e.g. a slot) to accommodate side-to-side cable movement, or different angles of the cable 22, in operation of the winch 18. In this context, side-to-side is in the direction of the rotational axis of the spool 62 and the different angles of the cable 22 are to either side of perpendicular to the rotational axis of the spool 62, as well as up and down (e.g. in and opposite to the direction of the force of gravity).

While described with regard to implementations in which the winch 18 is received within a front compartment 42 of the vehicle 10, a winch 18 could be received within a rear compartment 90 (FIG. 1) of the vehicle 10. In this arrangement, the cable 22 would extend through an opening in a rear body panel, such as below a liftgate of a sport utility vehicle, for example. The winch base 76 would be connected to vehicle substructure 20 surfaces available in that area of the vehicle 10, such as rear rails or support panels of the unibody substructure 20. Further, while described with reference to a vehicle 10 having a unibody substructure 20, the winch 18 may be received within a compartment formed in a vehicle having a body-on-frame structure, if desired. The winch base 76 would be connected to suitable rails of the frame, and may be located within an internal compartment as noted herein, including but not limited to beneath a hood of the vehicle and behind a front fascia of the vehicle.

Contrary to externally mounted winches, the internally mounted winch 18 is not directly exposed to the environment outside the vehicle and is more protected against the negative effects of rain, snow, dirt, mud, sun and the like. The internal winch 18 is not directly visible from outside the vehicle, which can present a cleaner vehicle appearance that may be desired by some consumers. Further, the internal winch has a lesser impact on vehicle aerodynamics and fuel efficiency compared to an externally mounted winch, which can be important to the driveable range of an electric vehicle.

What is claimed is:

1. An electric vehicle, comprising:
a vehicle substructure;
vehicle body panels coupled to the vehicle substructure;
a compartment bounded on multiple sides by the vehicle body panels;
a winch received within the compartment, the winch including a cable that extends through an opening formed in one of the vehicle body panels so that the cable is accessible from an outside of the vehicle; and
a winch base coupled to the winch and to the vehicle substructure to support the winch during operation of the winch.

2. The vehicle of claim 1 wherein the body panels define a front end of a vehicle body and include a hood and a front fascia.

3. The vehicle of claim 2 wherein the cable opening is provided in the front fascia.

4. The vehicle of claim 2 wherein the winch is accessible from outside the vehicle when the hood is in an open position.

5. The vehicle of claim 1 which includes an electric drive module secured to the vehicle substructure and wherein the winch base and the winch are located above the electric drive module.

6. The vehicle of claim 2 which includes an electric drive module secured to the vehicle substructure and wherein the winch base and the winch are located above the electric drive module, below the hood and behind the front fascia.

7. The vehicle of claim 1 wherein a storage compartment is defined in the front compartment, the storage compartment is defined in part by a body received in the front compartment and the winch is received in the storage compartment.

8. The vehicle of claim 7 wherein the winch base extends through openings formed in the body so that part of the winch base is received within the storage compartment and part of the winch base is located outside of the storage compartment.

9. The vehicle of claim 7 which includes a cover that separates a first part of the storage compartment in which the winch is located from a second part of the storage compartment.

10. The vehicle of claim 1 wherein the winch includes a casing having a first part and a second part, and a spool that extends between the first part and the second part, and wherein each of the first part and the second part are coupled to the winch base.

11. The vehicle of claim 2 wherein the body panels also include a pair of side panels arranged on opposite sides of the front fascia.

12. The vehicle of claim 5 which also includes a control module coupled to the electric drive module and wherein the winch base and the winch are also located above the control module.

13. The vehicle of claim 5 which also includes a cooling assembly within the front compartment and associated with the electric drive module, and wherein the cable is routed from the cable opening and to the winch in an area above the cooling assembly.

14. An electric vehicle, comprising:
a vehicle substructure including a pair of spaced apart rails extending in a fore-aft direction;
vehicle body panels coupled to the vehicle substructure, the vehicle body panels including a front fascia, a pair of side panels on opposite sides of the front fascia and a hood of the vehicle;
a front compartment bounded on multiple sides by the vehicle body panels;
an electric drive module received in the front compartment and connected to the vehicle substructure and arranged to provide propulsive force for the vehicle;
a winch received within the front compartment;
a cable coupled to the winch, the cable extending through an opening formed in the front fascia; and
a winch base coupled to the winch and to both of the rails.

15. The vehicle of claim 14 wherein a storage compartment is defined in the front compartment, the storage compartment is defined in part by a body received in the front compartment and the winch is received in the storage compartment.

16. The vehicle of claim 15 wherein the winch base extends through openings formed in the body so that part of the winch base is received within the storage compartment and part of the winch base is located outside of the storage compartment.

17. The vehicle of claim 14 wherein the winch base and the winch are located above the electric drive module, below the hood and behind the front fascia.

18. The vehicle of claim 14 which also includes a control module coupled to the electric drive module and wherein the winch base and the winch are located above the control module and the electric drive module.

19. The vehicle of claim 14 which also includes a cooling assembly within the front compartment and associated with the electric drive module, and wherein the cable is routed from the cable opening and to the winch in an area above the cooling assembly.
